(19) United States
(12) Patent Application Publication
(10) Pub. No.: US 2005/0201555 A1
(43) Pub. Date: Sep. 15, 2005

(54) System, method and apparatus for secure computation on encrypted data

(76) Inventors: I-Ling Yen, Plano, TX (US); Qingkai Ma, New York Mills, NY (US)

Correspondence Address: CHALKER FLORES, LLP, 12700 PARK CENTRAL, STE. 455, DALLAS, TX, 75251, US

(21) Appl. No.: 11/054,236

(22) Filed: Feb. 8, 2005

Related U.S. Application Data
(60) Provisional application No. 60/542,931, filed on Feb. 9, 2004.

(51) Int. Cl. H04K 1/00; H04L 9/00

(52) U.S. Cl. 380/30; 380/46

(57) ABSTRACT

The present invention provides a system, method and apparatus for secure computation on encrypted data that may include a server, a source(s) of encrypted data communicably coupled to the server and a key holder(s) communicably coupled to the server. The server is capable of receiving a request invoking a computation(s) using the encrypted data, requesting a pseudo key(s) for the encrypted data from the key holder(s), obtaining the encrypted data, performing the computation(s) on the encrypted data using the pseudo key(s) and providing the results of the computation(s). The key holder(s) are capable of receiving an encryption key(s) for the encrypted data, receiving the request for the pseudo key(s), computing the pseudo key(s) and providing the pseudo key(s) to the server.

### REFERENCE TO RELATED APPLICATIONS

This application claims priority to U.S. Provisional Patent Application No. 60/542,931 filed Feb. 9, 2004, which is herein incorporated by reference in its entirety.

### FIELD OF THE INVENTION

The present invention relates generally to the field of data processing and, more particularly, to a system, method and apparatus for secure computation on encrypted data.

### BACKGROUND OF THE INVENTION

Security protection mechanisms have been extensively studied in the past two decades. Unfortunately, hacking strategies have managed to keep pace with advances in security. When known security loopholes are patched, new attacks are invented. It is very difficult to keep hackers out of any system on the Internet. An effective solution to this problem is to keep confidential information encrypted so that even if the system is compromised, critical data can still remain secret. Regular encryption algorithms, however, require the encrypted data be decrypted at computation time. As a result, the data is vulnerable to attacks at computation time. The challenge is, therefore, how to perform operations on encrypted data without decrypting them; otherwise, intruders who manage to penetrate the system can monitor system memory and registers to compromise critical data and keys.

Secure computations have been investigated since the 1980's. One such secure computation concept is secure multiparty computation in which n parties are considered, where n≧3. Each confidential data item is partitioned into n secret shares and one share is given to one party. When an operation is to be performed on the secret data, the n parties perform the corresponding computation protocol on their data shares and the resulting shares held by the n parties are the secret shares of the new data. During the computation, each secret share remains private and is only known by its holder. Many secure multiparty computation algorithms have been proposed since. One common problem of these algorithms is that they only consider arithmetic operations, and do not support general computation. Also, these algorithms involve heavy communication overhead and cannot be widely used.

Another secure computation model is secure circuit evaluation. In a secure circuit evaluation model, two parties, say Alice and Bob, are considered. Alice has secret input x and Bob has circuit C, and Alice or Bob needs to compute C(x). Though Bob performs the computation of C(x), he should not be able to derive x. Several secure circuit evaluation protocols have been proposed. One of them is based on the properties of quadratic residues. The secure circuit evaluation protocols involve very heavy communication overhead, worse than the case of multiparty computation. Specifically, they need one round of message communication for each binary AND operation.

Cryptocomputing extends the research in secure computation, e.g., a non-interactive cryptocomputing scheme for NC¹ circuits with the technology of inattentive circuit evaluation. Since the message size will be exponential to the depth of the circuit, this method only supports NC¹ circuits and can not be used for general circuits. Another approach involves cryptocomputing with rationals, which has reasonable performance but very limited computation power. This method only supports addition operation and multiplication by a constant. Another approach introduces “Randomizing polynomials” to achieve round-efficient secure computation. A vector of low-degree (at most 3) polynomials is used to represent Boolean functions. Since low-degree polynomials incur less communication rounds in secure multiparty computation, this representation can greatly reduce the number of communication rounds. However, the communication complexity can be quadratic in the branching programs.

There is, therefore, a need for a secure computation protocol that provides full computation power and is secure, efficient, economical and easy to implement.

### SUMMARY OF THE INVENTION

The present invention provides a new secure computation scheme with the focus on the protection of data privacy by allowing data to stay encrypted throughout its lifecycle. Only when the data has to be given in a raw format to a human client, need the data be decrypted. So, the data is protected even if the server system is hacked and compromised. As a result, the present invention can be used by anyone that has critical data (that should be kept private), whether the data is in a database or not. Moreover, the present invention provides full computation power (e.g., arithmetic, Boolean, comparison, bit-wise, program flow control operations, etc.), allows aggregate processing of multiple operations, only needs one message passing for each set of aggregate operations, and can be implemented in hardware or software. As a result, the present invention provides secure computation protocol that is secure, efficient, economical, easy to implement and outperforms existing schemes.

The present invention differs from the secure circuit evaluation model in that real number computations are considered instead of binary gates. Secure circuit evaluation protocols need on message communication for each binary AND operation. Also, secure circuit evaluation protocols generally have more expensive computation steps. Hence, the performance of the present invention is much better than that of secure circuit evaluation protocols. Moreover, the present invention can be easily adapted to integer or rational computation.

The present invention is also different from secure multiparty computation approaches in that full-power computations are considered instead of just arithmetic operations. Moreover, the present invention is more efficient than secure multiparty computation approaches.

More specifically, the present invention provides a method for secure computation of encrypted data. A request invoking one or more computations using the encrypted data is received and the request is authenticated. One or more pseudo keys are then obtained for the encrypted data. The encrypted data is obtained and the one or more computations are performed on the encrypted data using the pseudo keys. The results (in encrypted form or a TRUE/FALSE result) of the one or more computations are then provided.

The present invention also provides a method for secure computation of encrypted data wherein a request for one or more pseudo keys to perform one or more computations using the encrypted data is received. The one or more pseudo keys are computed for the encrypted data based on one or more encryption keys. Thereafter, the one or more pseudo keys are provided to the requestor. When new data, such as results of the one or more computations or intermediate results of such computations, are generated, new encryption keys are generated. Note that each of the methods described above can be implemented as a computer program embodied on a computer readable medium wherein each step represents one or more code segments of the computer program.

In addition, the present invention provides an apparatus for secure computation of encrypted data that includes a server, one or more sources of encrypted data communicably coupled to the server and one or more key holders communicably coupled to the server. The server is capable of receiving a request invoking one or more computations using the encrypted data, requesting one or more pseudo keys for the encrypted data from the one or more key holders, obtaining the encrypted data, performing the one or more computations on the encrypted data using the pseudo keys and providing the results of the one or more computations. The one or more key holders are capable of receiving one or more encryption keys for the encrypted data, receiving the request for one or more pseudo keys, computing the one or more pseudo keys and providing the one or more pseudo keys to the server.

Moreover, the present invention provides a system for secure computation of encrypted data that includes one or more client devices, a server communicably coupled to the one or more client devices via a network, one or more sources of encrypted data communicably coupled to the server, one or more key holders communicably coupled to the server and an encryption module communicably coupled to the server, the one or more sources of encrypted data or the one or more key holders. The encryption module is capable of obtaining data to be encrypted, creating one or more encryption keys for the data, encrypting the data using the one or more encryption keys, sending the encrypted data to the one or more sources of encrypted data and sending the one or more encryption keys to the one or more key holders. The server is capable of receiving a request invoking one or more computations using the encrypted data, requesting one or more pseudo keys for the encrypted data from the one or more key holders, obtaining the encrypted data, performing the one or more computations on the encrypted data using the pseudo keys and providing the results of the one or more computations. The one or more key holders are capable of receiving one or more encryption keys for the encrypted data, receiving the request for one or more pseudo keys, computing the one or more pseudo keys and providing the one or more pseudo keys to the server.

Other features and advantages of the present invention will be apparent to those of ordinary skill in the art upon reference to the following detailed description taken in conjunction with the accompanying drawings.

### BRIEF DESCRIPTION OF THE DRAWINGS

The above and further advantages of the invention may be better understood by referring to the following description in conjunction with the accompanying drawings, in which:

FIG. 1 depicts a block diagram of a system in accordance with one embodiment of the present invention;

FIG. 2 depicts a flow chart for the encryption module processing in accordance with one embodiment of the present invention;

FIG. 3 depicts a flow chart for the server processing in accordance with one embodiment of the present invention; and

FIG. 4 depicts a flow chart for the key holder processing in accordance with one embodiment of the present invention.

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

The present invention provides a new secure computation scheme with the focus on the protection of data privacy by allowing data to stay encrypted throughout its lifecycle. Only when the data has to be given in a raw format to a human client, need the data be decrypted. So, the data is protected even if the server system is hacked and compromised. As a result, the present invention can be used by anyone that has critical data (that should be kept private), whether the data is in a database or not. Moreover, the present invention provides full computation power, allows aggregate processing of multiple operations, only needs one message passing for each set of aggregate operations, and can be implemented in hardware or software. As a result, the present invention provides secure computation protocol that is secure, efficient, economical, easy to implement and outperforms existing schemes.

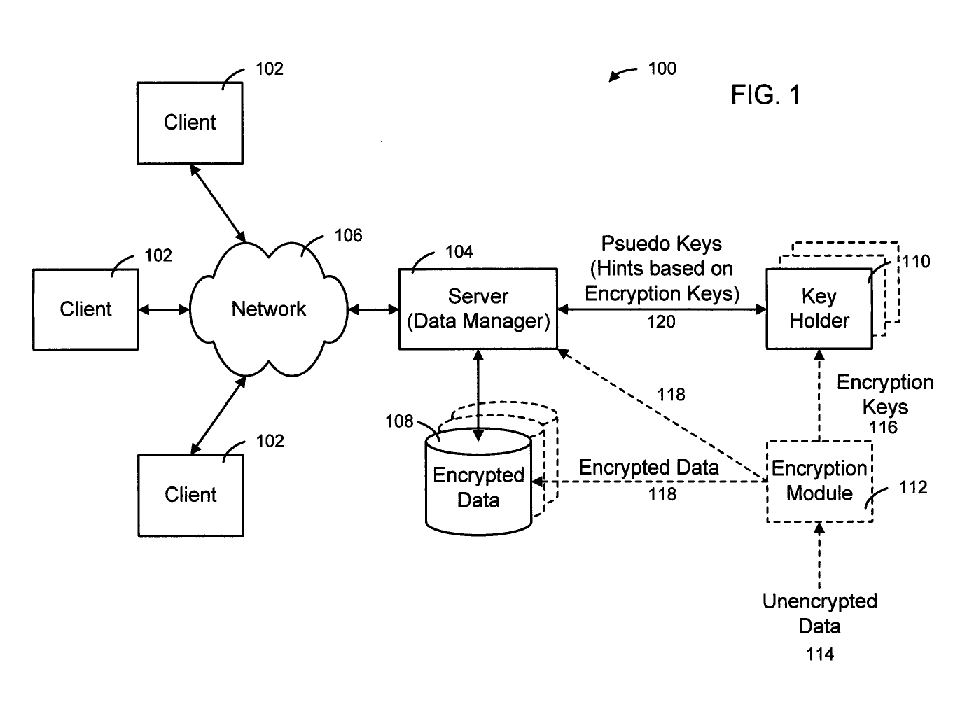

Now referring to FIG. 1, a block diagram of a system 100 in accordance with one embodiment of the present invention is shown. System 100 includes one or more client devices 102, a server 104 communicably coupled to the one or more client devices 102 via a network 106, one or more sources 108 (repository or data storage device) of encrypted data communicably coupled to the server 104, one or more key holders 110 communicably coupled to the server 104 and an encryption module 112 communicably coupled to the server 104, the one or more sources 108 of encrypted data or the one or more key holders 110. The client devices 102 can be a computer, laptop computer, mobile computing device, mobile communications device, personal data assistant (“PDA”), or any other local or remote device in which it is desirable to access, use or perform computations on encrypted data. The network 106 may include one or more local or wide area networks, which can be private or public (e.g., the Internet, etc.). Depending on the circumstances, the communication links between the client devices 102 and the server 104 can be secure (i.e., encrypted) or unsecured (i.e., unencrypted). Moreover, the communication links can be hardwired voice lines and/or data lines, wireless, optical, satellite or any combination thereof. The client devices 102 can also be directly connected to the server 104.

The server 104 or data manager can be one or more computers or any other device(s) capable of managing encrypted data 118 and processing requests from the client devices 102 to access and perform computations on the encrypted data 118 stored in the one or more sources 108 of encrypted data. The server 104 and one or more sources 108 can be integrated into a single device. In operation, the server 104 receives a request from the one or more client devices 102 that invokes one or more computations using the encrypted data 118. The server 104 then requests one or more pseudo keys 120 for the encrypted data from the one or more key holders 110 and obtains the encrypted data 118 from the one or more sources 108 of encrypted data. The one or more pseudo keys 120 are encryption hints allow the server 104 to manipulate (perform computations or operations) the encrypted data 118 without revealing or compromising the encryption keys 116 or the unencrypted data 114 (original data). The server 104 then performs the one or more computations on the encrypted data 118 using the pseudo keys 120. During computation, the server 104 may generate new encrypted data 118 that are then stored in the one or more sources 108 of encrypted data 118. The server 104 then provides the results (in encrypted form or a TRUE/FALSE result) of the one or more computations to the appropriate client device 102. The one or more pseudo keys 120 prevent the results from revealing or compromising the encryption keys 116 or the unencrypted data 114 (original data). The one or more computations can be any operation supported by a computer programming language (e.g., arithmetic operations, Boolean operations, bit-wise operations or program flow control operations (e.g., data comparison statements, if statements and goto statements, etc.), etc.) and can be performed in an aggregate manner if the encrypted data to be operated on are known. The operations may also result in new encrypted data. As demonstrated below, for all operations, the computation and communication overhead are very low.

The one or more key holders 110 are capable of receiving one or more encryption keys 116 for the encrypted data 118 in the initialization phase, receiving the request for one or more pseudo keys 120, computing the one or more pseudo keys 120 and providing the one or more pseudo keys 120 to the server 104. The one or more pseudo keys 120 are derived from one or more encryption keys that were used to create the encrypted data. In addition, the one or more pseudo keys 120 can be generated before or after receiving the request from the server 104, and provided to the server 104 in one or more messages. The key holder 110 may also create new encryption keys for each request or for new encrypted data that results from the computations performed by the server 104. The one or more key holders 110 can be, therefore, any device capable of securely storing the encryption keys, processing the requests for pseudo keys 130 and computing the pseudo keys 130. Accordingly, the one or more key holders 110 should be isolated and shielded from the network 106 so that it only communicates with an authorized server 104. The one or more key holders 110 should also be physically separated and protected from server 104 so that the server 104 can only obtain the pseudo keys 120 of the encrypted data 118, but not the encryption keys 116.

Multiple key holders 110 can be used to improve system performance, security, reliability and integrity. The encryption keys can be distributed and stored in multiple key holders 110 wherein each key holder 110 holds a non-overlapping or overlapping subset of the one or more encryption keys. Additional key holders 110 can be used as secondary sources so that the server 104 can verify the correctness of the one or more pseudo keys 120 obtained from the primary key holder(s) 110. For example, the server 104 can obtain one or more second pseudo keys from the second source or secondary key holder and compare the one or more pseudo keys 120 to the one or more second pseudo keys. The second source or secondary key holder can be a replica of the first source (key holder 110) or simply keep one or more digests of the pseudo keys 120 generated by the first source (key holder 110). The one or more key holders 110 can also control access to the encrypted data by controlling access to the encryption keys 116 for the data. For example, the one or more key holders 110 may receive a request for one or more of the encryption keys 116, determine whether a sender of the request is allowed to access the requested encryption keys 116 and provide the requested encryption keys 116 to the sender whenever the sender is allowed to access the requested encryption keys. The key holders 110 can also be recursive. For example, the encryption keys 116 stored at the first key holder 110 can be encrypted using the present invention and the encryption keys of the encryption keys 116 can be stored at the second key holder 110.

The encryption module 112 is capable of obtaining data to be encrypted (unencrypted data 114), creating one or more encryption keys 116 for the data, encrypting the data 114 using the one or more encryption keys 116, sending the encrypted data 118 to the one or more sources 108 of encrypted data and storing the one or more encryption keys 116 to the one or more key holders 110. The procedure for storing the encryption keys 116 to the one or more key holders 110 should be highly secure. Note that the encryption module 112 should be a standalone component to ensure the data and key secrecy and should be used only at the initialization time to process the existing unencrypted data 114. When the sever 104 starts to process requests from the client devices 102, the encryption module 112 is no longer needed. The encryption module 112 creates the one or more encryption keys 116 or the data 114 by decomposing the data 114 into one or more partitions and creating one or more encryption keys 116 for each partition. As a result, the encrypted data 118 may include N partitions of encrypted data 118 created with M encryption keys 116 where N is greater than or equal to one and M is greater than N. Each encryption key 116 can be independently and randomly created or created from a single encryption key. The encrypted data 118 can be stored in the one or more sources 108 directly by the encryption module 112 or through the server 104.

The data 114 can be decomposed using a decomposition polynomial where:
d represents the data and d₁, d₂, . . . , and d_{N} represent the N partitions of the data;
the decomposition polynomial is a linear function of the N partitions d₁, d₂, . . . , d_{N};
D(d₁, d₂, . . . , d_{N}) denotes the decomposition polynomial;
D(d₁, d₂, . . . , d_{N})=c₁*d₁+c₂*d₂+ . . . +c_{N}*d_{N}, where c₁, c₂, . . . , c_{N} are chosen coefficients of the decomposition polynomial and D(d₁, d₂, . . . , d_{N})=d; and
the N partitions d₁, d₂, . . . , and d_{N} can be chosen arbitrarily as long as D(d₁, d₂, . . . , d_{N})=d is satisfied.
   For example, N is 2 and the decomposition polynomial is D(d₁, d₂)=c₁*d₁+c₂*d₂. Or, c₂=1 and the decomposition polynomial is D(d₁, d₂)=c₁*d₁+d₂. The data 114 can also be decomposed using a nonlinear polynomial function of the N partitions d₁, d₂, . . . , d_{N}.

The data 114 can then be encrypted using a conversion polynomial and a key-based coding function where:
d represents the data and d₁, d₂, . . . , and d_{N} represent N partitions of the data using a decomposition function;
Kᵢ represents the i-th encryption key of the M encryption keys;
e represents the encrypted form of the secret data d;
the encrypted form e is a vector of M elements (e₁, e₂, . . . , e_{M});
the i-th element of the encrypted form e is es and eᵢ is computed from the i-th encryption function;
the i-th encryption function consists of the i-th conversion polynomial and the i-th key-based coding function;
each conversion polynomial is a linear function of the N partitions d₁, d₂, . . . , d_{N};
E^{C}ᵢ(d₁, d₂, . . . , d_{N}) denotes the i-th conversion polynomial, where i=1, 2, . . . , M;
E^{C}ᵢ(d₁, d₂, . . . , d_{N})=sᵢ₁*d₁+sᵢ₂*d₂+ . . . +s_{iN}*d_{N}, where sᵢ₁, sᵢ₂, . . . , s_{iN} are chosen coefficients of the conversion polynomial E^{C}ᵢ (d₁, d₂, . . . , d_{N});
E^{C}₁(d₁, d₂, . . . , d_{N}), E^{C}₂(d₁, d₂, . . . , d_{N}), . . . , and E^{C}_{M}(d₁, d₂, . . . , d_{N}) form a set of linear equations that converts the N partitions d₁, d₂, . . . , and d_{N} into M values;
E^{K}ᵢ(Kᵢ, E^{C}ᵢ(d₁, d₂, . . . , d_{N})) denotes the i-th key-based coding function; and
E^{K}ᵢ(Kᵢ, E^{C}ᵢ(d₁, d₂, . . . , d_{N}))=eᵢ wherein the i-th key-based coding function applies the i-th key Kᵢ to the result computed from the i-th conversion function E^{C}ᵢ (d₁, d₂, . . . , d_{N}) to obtain the encrypted form eᵢ.
   For example, the conversion polynomial is E^{C}ᵢ(d₁, d₂)=sᵢ₁*d₁+sᵢ₂*d₂, where i=1, 2, . . . , M. The key-based coding functions can be E^{K}ᵢ(Kᵢ, E^{C}ᵢ(d₁, d₂, . . . , d_{N}))=Kᵢ*E^{C}ᵢ(d₁, d₂, . . . , d_{N}), where i=1, 2, . . . , M. For example, M=2 and the key-based coding functions are E^{K}₁(K₁, E^{C}₁(d₁, d₂))=K₁*s₁₁*d₁+K₁*s₁₂*d₂ and E^{K}₂(K₂, E^{C}₂(d₁, d₂))=K₂*s₂₁*d₁+K₂*s₂₂*d₂.

The present invention can be applied to database systems, mobile agent systems and outsourcing systems, etc. For example, in a mobile agent system, mobile agent X, representing a client C, migrates to a remote site S. X carries encrypted data of C and performs computation at S according to the present invention. C acts as a key holder, sends hint messages (pseudo keys) to S. Likewise in an outsourcing system, consider two companies, A and B. A outsources its business logics to company B, but A would like to keep some data private from B. All A's business logic can be implemented and hosted at B's site. Key holder will be kept at A's site. A can protect its secret data using the present invention.

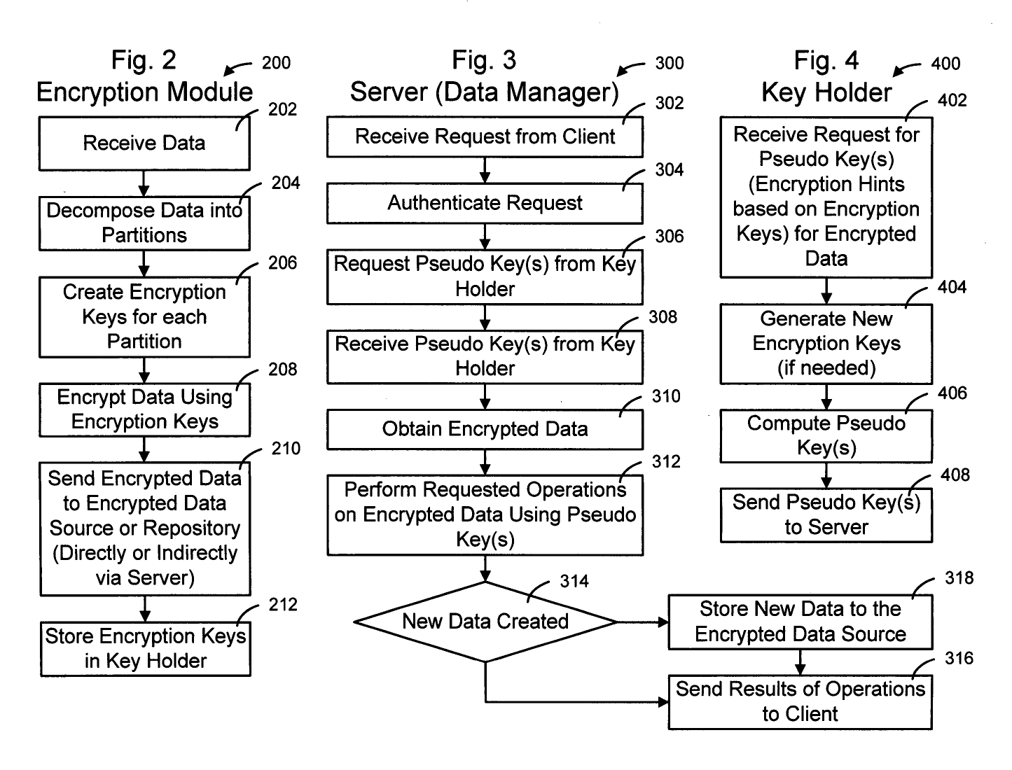

Referring now to FIG. 2, a flow chart for the encryption module 112 (FIG. 1) processing 200 in accordance with one embodiment of the present invention is shown. As described above and below, the encryption module 112 (FIG. 1) receives or obtains the data 114 (FIG. 1) to be encrypted in block 202 and decomposes the data 114 (FIG. 1) into partitions in block 204. One or more encryption keys 116 (FIG. 1) are created for each partition in block 206 and the data 114 (FIG. 1) is encrypted using the one or more encryption keys in block 208. The encrypted data 118 (FIG. 1) is then sent to the one or more sources 108 (FIG. 1) either directly or indirectly via server 104 (FIG. 1) in block 210 and the one or more encryption keys 116 (FIG. 1) are stored in the one or more key holders 110 (FIG. 1) in block 212. Additional details regarding this process were previously discussed in reference to FIG. 1 and are also discussed below.

Now referring to FIG. 3, a flow chart for the server 104 (FIG. 1) processing 300 in accordance with one embodiment of the present invention is shown. The server 104 (FIG. 1) receives a request from one of the client devices 102 (FIG. 1) that invokes one or more computations or operations using the encrypted data 118 (FIG. 1) in block 302 and the request is authenticated in block 304. Note that the request authentication may have already been completed by a prior authentication of the client 102 (FIG. 1). One or more pseudo keys 120 (FIG. 1) are then obtained for the encrypted data 118 (FIG. 1). This can be accomplished by sending a request to the appropriate key holder 110 (FIG. 1) in block 306 and receiving the one or more pseudo keys 120 (FIG. 1) from the appropriate key holder 110 (FIG. 1) in block 308. The encrypted data 118 (FIG. 1) is obtained from the one or more sources 108 (FIG. 1) in block 310 and the one or more requested computations or operations are performed on the encrypted data 118 (FIG. 1) using the pseudo keys 120 (FIG. 1) in block 312. If the computations or operations do not generate new encrypted 118 (FIG. 1), as determined in decision block 314, the results (in encrypted form or a TRUE/FALSE result) of the one or more computations or operations are provided to the client device 102 (FIG. 1) in block 316. If, however, the computations or operations generate new encrypted data 118 (FIG. 1), as determined in decision block 314, the new encrypted data 118 (FIG. 1) is stored in the one or more sources 108 (FIG. 1) in block 318. The results (in encrypted form or a TRUE/FALSE result) of the one or more computations or operations are then provided to the client device 102 (FIG. 1) in block 316. Additional details regarding this process were previously discussed in reference to FIG. 1 and are also discussed below.

Referring now to FIG. 4, a flow chart for the key holder 110 (FIG. 1) processing 400 in accordance with one embodiment of the present invention is shown. A request for one or more pseudo keys 120 (FIG. 1) to perform one or more computations or operations using the encrypted data 118 (FIG. 1) is received in block 402. As previously described, the one or more pseudo keys 120 (FIG. 1) are encryption hints that are derived from the encryption keys 116 (FIG. 1) for the encrypted data 118 (FIG. 1). Moreover, the one or more key holders 110 (FIG. 1) receive the one or more encryption keys 116 (FIG. 1) for the encrypted data 118 (FIG. 1) from the encryption module 112 (FIG. 1) during the initialization phase. Note that the one or more key holders 110 (FIG. 1) may also receive a request for access to the one or more encryption keys 116 (FIG. 1). In such a case, the one or more key holders 110 (FIG. 1) will determine whether the sender of the request is allowed to access the requested encryption keys and only provide the requested encryption keys when the sender is allowed to access the requested encryption keys. Security alerts, lock-downs, logs, traces and other security response measures will typically be initiated whenever the sender of the request is not allowed to access the requested encryption keys. If the request involves new data, new encryption keys are generated in block 404. The one or more pseudo keys 120 (FIG. 1) are computed in block 406 and provided to the server 104 (FIG. 1) in block 408. The one or more key holders 110 (FIG. 1) can be further secured. Additional details regarding this process were previously discussed in reference to FIG. 1 and are also discussed below. Note that each of the methods described above can be implemented as a computer program embodied on a computer readable medium wherein each step represents one or more code segments of the computer program.

The present invention will now be described in reference to an example of two parties, Alice and Bob, where Bob wants to perform computations on Alice's encrypted data. Consider a secret data d, which is chosen arbitrarily by Alice and can be represented as d=f*x+y, where f is a fixed number and (x, y) is the decomposed form of d, which is chosen arbitrarily by Alice. Alice also chooses a pair (a, b) as the key pair for d and computes u=a*(x+y) and v=b*(x−y), where (u, v) is the encrypted form of d. Note that for different secret data, the key pairs can be different.

In the case of addition operations, consider two secret data d₁ and d₂. Let (u₁, v₁) and (u₂, v₂) be the encrypted form and (a₁, b₁) and (a₂, b₂) be the key pairs of d₁ and d₂, respectively. Alice sends (u₁, v₁) and (u₂, v₂) to Bob and Bob computes (u, v), where (u, v) are the encrypted form of d and d=d₁+d₂. The key for d, denoted as (a, b) can be computed by Alice to reconstruct d. Also, d=f*x+y. During the computation, all the key information is kept secret from Bob. Here, the relation between (u, v) and (u₁, v₁) and (u₂, v₂) is derived. First, the relation between d₁ and (u₁, v₁) can be expressed as:

$$2 {a}_{1} {b}_{1} {d}_{1} = {a}_{1} {b}_{1} ( 2 {fx}_{1} + 2 {y}_{1} ) \\ = {a}_{1} {b}_{1} ( ( f + 1 ) * ( {x}_{1} + {y}_{1} ) + ( f - 1 ) * ( {x}_{1} - {y}_{1} ) ) \\ = {b}_{1} ( f + 1 ) {u}_{1} + {a}_{1} ( f - 1 ) {v}_{1}$$

Similarly, 2a₂b₂d₂=b₂(f+1)u₂+a₂(f−1)v₂. Next, the relation between d and (u₁, v₁) and (u₂, v₂) can be derived.

$$2 {a}_{1} {b}_{1} {a}_{2} {b}_{2} d = {a}_{2} {b}_{2} ( 2 {a}_{1} {b}_{1} {d}_{1} ) + {a}_{1} {b}_{1} ( 2 {a}_{2} {b}_{2} {d}_{2} ) \\ = {a}_{2} {b}_{2} ( {b}_{1} ( f + 1 ) {u}_{1} + {a}_{1} ( f - 1 ) {v}_{1} ) + \\ {a}_{1} {b}_{1} ( {b}_{2} ( f + 1 ) {u}_{2} + {a}_{2} ( f - 1 ) {v}_{2} ) \\ = {a}_{2} {b}_{2} {b}_{1} ( f + 1 ) {u}_{1} + {a}_{2} {b}_{2} {a}_{1} ( f - 1 ) {v}_{1} + \\ {a}_{1} {b}_{1} {b}_{2} ( f + 1 ) {u}_{2} + {a}_{1} {b}_{1} {a}_{2} ( f - 1 ) {v}_{2} \qquad ( 1 )$$

Now, d can be decomposed into the form d=f*x+y. The decomposition is done by using A₁, A₂, B₁ and B₂ (chosen arbitrarily by Alice) to partition each of the 4 terms (in equation (1)) of 2a₁b₁a₂b₂d as follows.

$$2 {a}_{1} {b}_{1} {a}_{2} {b}_{2} d = [ {A}_{1} {a}_{2} {b}_{2} {b}_{1} ( f + 1 ) {u}_{1} + {B}_{1} {a}_{2} {b}_{2} {a}_{1} ( f - 1 ) {v}_{1} + {A}_{2} {a}_{1} {b}_{1} {b}_{2} ( f + 1 ) {u}_{2} + {B}_{2} {a}_{1} {b}_{1} {a}_{2} ( f - 1 ) {v}_{2} ] + [ ( 1 - {A}_{1} ) {a}_{2} {b}_{2} {b}_{1} ( f + 1 ) {u}_{1} + ( 1 - {B}_{1} ) {a}_{2} {b}_{2} {a}_{1} ( f - 1 ) {v}_{1} + ( 1 - {A}_{2} ) {a}_{1} {b}_{1} {b}_{2} ( f + 1 ) {u}_{2} + ( 1 - {B}_{2} ) {a}_{1} {b}_{1} {a}_{2} ( f - 1 ) {v}_{2} ] \qquad ( 2 )$$

Now, (x, y) can be computed from equation (2). Note that how to decompose d into f*x+y is already determined by A₁, A₂, B₁, and B₂ chosen by Alice.

$$\begin{matrix}x = [ {A}_{1} {a}_{2} {b}_{2} {b}_{1} ( f + 1 ) {u}_{1} + {B}_{1} {a}_{2} {b}_{2} {a}_{1} ( f - 1 ) {v}_{1} + \\ {A}_{2} {a}_{1} {b}_{1} {b}_{2} ( f + 1 ) {u}_{2} + {B}_{2} {a}_{1} {b}_{1} {a}_{2} ( f - 1 ) {v}_{2} ] / \\ ( 2 {a}_{1} {b}_{1} {a}_{2} {b}_{2} f )\end{matrix} \\ and \\ y = [ ( 1 - {A}_{1} ) {a}_{2} {b}_{2} {b}_{1} ( f + 1 ) {u}_{1} + ( 1 - {B}_{1} ) {a}_{2} {b}_{2} {a}_{1} ( f - 1 ) {v}_{1} + \\ ( 1 - {A}_{2} ) {a}_{1} {b}_{1} {b}_{2} ( f + 1 ) {u}_{2} + ( 1 - {B}_{2} ) {a}_{1} {b}_{1} {a}_{2} ( f - 1 ) {v}_{2} ] / \\ ( 2 {a}_{1} {b}_{1} {a}_{2} {b}_{2} f ) \qquad ( 3 )$$

Now, u and v can be computed from (u₁, v₁) and (u₂, v₂). To allow Bob to compute u and v, Alice needs to provide coefficients A₁ᵤ, A₂ᵤ, B₁ᵤ, B₂ᵤ, A₁ᵥ, A₁ᵥ, B₁ᵥ, and B₂ᵥ as defined below. These coefficients are derived from (a₁, b₁) and (a₂, b₂). To further protect the key pairs, Alice also chooses two secret multipliers m and n in the computation. Finally, from equation (3):
u=2ma₁b₁a₂b₂(x+y)=A₁ᵤu₁+B₁ᵤv₁+A₂ᵤu₂+B₂ᵤv₂ and
v=2ma₁b₁a₂b₂(x−y)=A₁ᵥu₁+B₁ᵥv₁+A₂ᵥu₂+B₂ᵥv₂, where
A₁ᵤ=[(1−f)/f*A₁+1]*ma₂b₂b₁*(f+1) and A₁ᵥ=[(1+f)/f*A₁−1]*na₂b₂b₁(f+1)
B₁ᵤ=[(1−f)/f*B₁+1]*ma₂b₂a₁*(f−1) and B₁ᵥ=[(1+f)/f*B₁−1]*na₂b₂a₁(f−1)
A₂ᵤ=[(1−f)/f*A₂+1]*ma₁b₁b₂*(f+1) and A₂ᵥ=[(1+f)/f*A₂−1]*na₁b₁b₂(f+1)
B₂ᵤ=[(1−f)/f*B₂+1]*ma₁b₁a₂*(f−1) and B₂ᵥ=[(1+f)/f*B₂−1]*na₁b₁a₂(f−1)
   And, the key pair for d is (a,b)=(2ma₁b₁a₂b₂,2na₁b₁a₂b₂).

The protocol executed by Alice and Bob for addition is, thus, as follows.
1. Alice computes A₁ᵤ, A₂ᵤ, B₁ᵤ, B₂ᵤ, A₁ᵥ, A₂ᵥ, B₁ᵥ, B₂ᵥ and send these values to Bob.
2. Bob computes u=A₁ᵤu₁+B₁ᵤv₁+A₂ᵤu₂+B₂ᵤv₂ and v=A₁ᵥu₁+B₁ᵥv₁+A₂ᵥu₂+B₂ᵥv₂, and keeps (u, v) as the encrypted form of d=d₁+d₂.
3. Alice computes (a,b)=(2ma₁b₁a₂b₂,2na₁b₁a₂b₂) and stores it as the key pair for d=d₁+d₂.
   With all the information Bob can get during the addition computation, he cannot derive any information about d, d₁, or d₂ and their key pairs. Subtraction operations will work in a similar manner.

Now in the case of multiplication operations, consider the same notation and numbers as defined in addition except that d=d₁*d₂. Similar to the case for addition operation, the relation between d and (x₁, y₁) and (x₂, y₂) is derived first:
d=(f*x₁+y₁)*(f*x₂+y₂)=f²x₁x₂+fx₁y₂+fy₁x₂+y₁y₂. (4)

Next, d can be represented by (u₁, vᵢ) and (u₂, v₂). First,
r₁=u₁u₂/(a₁a₂)=x₁x₂+x₁y₂+x₂y₁+y₁y₂
r₂=u₁v₂/(a₁b₂)=x₁x₂−x₁y₂+x₂y₁−y₁y₂
r₃=u₂v₁/(a₂b₁)=x₁x₂+x₁y₂−x₂y₁−y₁y₂
r₄=v₁v₂/(b₁b₂)=x₁x₂−x₁y₂−x₂y₁+y₁y₂
Note that that r₁, r₂, r₃, and r₄ are variables newly defined for convenience in derivation. Now d should be represented as d=α*r₁+β*r₂+γ*r₃*v₁+δ*r₄, where

$$d = α * {r}_{1} + β * {r}_{2} + γ * {r}_{3} + δ * {r}_{4} \\ = ( α + β + γ + δ ) {x}_{1} {x}_{2} + ( α - β + γ - δ ) {x}_{1} {y}_{2} + \\ ( α + β - γ - δ ) {x}_{2} {y}_{1} + ( α - β - γ + δ ) {y}_{1} {y}_{2} \qquad ( 5 )$$

From equations (4) and (5), 4α=f²+f+1, 4β=4γ=f²−1, 4δ=f²−2f+1 for a fixed f. Here, if f=3 is chosen, the result is α=4, β=2, γ=2, δ=1. The relation between d and (u₁, v₁) and (u₂, v₂) can then be expressed as:

$${a}_{1} {b}_{1} {a}_{2} {b}_{2} * d = {a}_{1} {b}_{1} {a}_{2} {b}_{2} * ( α * {r}_{1} + β * {r}_{2} + γ * {r}_{3} + δ * {r}_{4} ) \\ = α {b}_{1} {b}_{2} {u}_{1} {u}_{2} + β {a}_{2} {b}_{1} {u}_{1} {v}_{2} + γ {a}_{1} {b}_{2} {u}_{2} {v}_{1} + \\ δ {a}_{1} {a}_{2} {v}_{1} {v}_{2} \\ = 4 {b}_{1} {b}_{2} {u}_{1} {u}_{2} + 2 {a}_{2} {b}_{1} {u}_{1} {v}_{2} + 2 {a}_{1} {b}_{2} {u}_{2} {v}_{1} + \\ {a}_{1} {a}_{2} {v}_{1} {v}_{2} \qquad ( 6 )$$

Now, d can be decomposed into the form d=f*x+y. The decomposition is done by arbitrarily choosing (by Alice) A₁, A₂, A₃ and A₄ to partition each of the 4 terms (in equation (6)) of 2a₁b₁a₂b₂d as follows:
2a₁b₁a₂b₂d=[4A₁b₁b₂u₁u₂+2A₂a₂b₁u₁v₂+2A₃a₁b₂u₂v₁+A₄a₁a₂v₁v₂]+
[4(1−A₁)b₁b₂u₁u₂+2(1−A₂)a₂b₁u₁v₂+2(1−A₃)a₁b₂u₂v₁+(1−A₄)a₁a₂v₁v₂] (7)

From equation (7), (x, y) can be computed.
x=[4A₁b₁b₂u₁u₂+2A₂a₂b₁u₁v₂+2A₃a₁b₂u₂v₁+A₄a₁a₂v₁v₂]/(a₁b₁a₂b₂f) and y=[4(1−A₁)b₁b₂u₁u₂+2(1−A₂)a₂b₁u₁v₂+2(1−A₃)a₁b₂u₂v₁+(1−A₄)a₁a₂v₁v₂]/(a₁b₁a₂b₂f)
   Now, u and v can be computed from (u₁, v₁) and (u₂, v₂). To allow Bob to compute u and v, Alice needs to provide coefficients A₁ᵤ, A₂ᵤ, B₁ᵤ, B₂ᵤ, A₁ᵥ, A₁ᵥ, B₁ᵥ, and B₂ᵥ as defined below. These coefficients are derived from (a₁, b₁) and (a₂, b₂). To further protect the key pairs, Alice also chooses two secret multipliers m and n such that the key pair for d is (a,b)=(ma₁b₁a₂b₂,na₁b₁a₂b₂). Together,
   u=ma₁b₁a₂b₂(x*y)=A₁ᵤu₁u₂+A₂ᵤu₁v₂+A₃ᵤv₁u₂+A₄ᵤv₁*v₂ and
   v=na₁b₁a₂b₂=A₁ᵥu₁u₂+A₂ᵥu₁v₂+A₃ᵥv₁u₂+A₄ᵥv₁v₂, where
A₁ᵤ=[(1−f)/f*A₁+1]*4mb₁b₂ and A₁ᵥ=[A₁*(1+f)/f−1]*4nb₁b₂
A₂ᵤ=[(1−f)/f*A₂+1]*2ma₂b₁ and A₂ᵥ=[A₂*(1+f)/f−1]*2na₂b₁
A₃ᵤ=[(1−f)/f*A₃+1]*2ma₁b₂ and A₃ᵥ=[A₃*(1+f)/f−1]*2na₁b₂
A₄ᵤ=[(1−f)/f*A₄+1]*ma₁a₂ and A₄ᵥ=[A₄*(1+f)/f−1]*na₁a₂

The protocol executed by Alice and Bob for multiplication is, thus, as follows.
1. Alice computes A₁ᵤ, A₂ᵤ, A₃ᵤ, A₄ᵤ, A₁ᵥ, A₂ᵥ, A₃ᵥ, A₄ᵥ and send these values to Bob.
2. Bob computes u=A₁ᵤu₁u₂+A₂ᵤu₁v₂+A₃ᵤv₁u₂+A₄ᵤv₁*v₂ and v=A₁ᵥu₁u₂+A₂ᵥu₁v₂+A₃ᵥv₁u₂+A₄ᵥv₁v₂, and keeps (u, v) as the encrypted form of d₁*d₂.
3. Alice computes (a,b)=(ma₁b₁a₂b₂,na₁b₁a₂b₂) and store it as the key for for d₁*d₂.
   With all the information Bob can get during the multiplication computation, he cannot derive any information about d, d₁, or d₂ and their key pairs. The operations for division are similar.

In the case of test operations, i.e., to execute “if (d>0)”, the input d is multiplied by a positive number d′ using the multiplication protocol previously described. d′ is a random number select by Alice to protect the secrecy of d. Assume that dₘ=d*d′=fxₘ+yₘ. Let (aₘ, bₘ) denote the key pairs for dₘ and (uₘ, vₘ) denote the encrypted form of dₘ. Let n be another random number chosen by Alice. Now,

$$2 {d}_{m} = 2 ( {fx}_{m} + {y}_{m} ) \\ = [ f ( {nb}_{m} {u}_{m} + {na}_{m} {v}_{m} ) + ( {nb}_{m} {u}_{m} - {na}_{m} {v}_{m} ) ] / ( {na}_{m} {b}_{m} ) \\ = [ ( f + 1 ) {nb}_{m} {u}_{m} + ( f - 1 ) {na}_{m} {v}_{m} ] / ( {na}_{m} {b}_{m} )$$

If Bob computes (f+1)nbₘuₘ+(f−1)naₘvₘ and Alice tells Bob whether naₘbₘ>0, Bob can know whether d>0.

So the protocol for test operations is as follows:
1. Alice chooses a random number d′, d′>0 and another random number n, n≠0. She decomposes d′ into (u′, v′). Alice sends (u′, v′), corresponding coefficients for computing d*d′, {naₘ,nbₘ}, and the sign of naₘbₘ to Bob.
2. Bob performs the multiplication protocol to compute (uₘ, vₘ), where dₘ=d*d′. Then, he computes (f+1)nbₘuₘ+(f−1)naₘvₘ. If both (f+1)nbₘuₘ+(f−1)naₘvₘ and naₘbₘ are greater than 0 or both of them are less than 0, then d>0. Otherwise d≦0.
   From the information Bob gets, he can only get the value of bₘ/aₘ, from which he can infers nothing because both n and d′ are randomly chosen and kept by Alice. This also works for logical comparison of encrypted data (e.g., equal to, less than, greater than, etc.).

With respect to performance analysis, the secure computation schemes are usually evaluated by the number of messages and the number of message passing rounds. In the present invention, for all operations, only one message from Alice to Bob is needed to finish the computation.

In the conventional secure multi-party computation, on the other hand, the lower bound of the message passing rounds and number of messages are O(n) and O(n²) respectively for a non-parallel t-private protocol, in which n is the number of parties involved in the computation and n≧2t+1, where t is O(n). A protocol is t-private if no collection of t players, while following the protocol exactly, gains any additional information about the other n−t secret inputs beyond what is necessarily revealed by knowing their t secret inputs and the output. Some of the secure circuit evaluation schemes require one round of interaction during AND gate evaluation (It only considers AND and NOT gates. OR gate can be simulated by the combination of those two.) There are two messages transmitted between Alice and Bob for each such gate evaluation. Thus, the communication complexity of secure circuit evaluation is O(n_{and}) where n_{and} is the number of and gates, a value that is big even for the addition of two real numbers. In the non-interactive cryptocomputing scheme for NC¹ circuits, the number of messages for this so-called symmetrically-secure cryptocomputing scheme is also one. The problem is that it can only supports NC¹ circuits and can not be used for general circuits. The message size will grow exponentially as the depth of the evaluation circuit increases. The following table gives the comparisons of several secure computation approaches.

TABLE 1
Communication overhead comparison

| | | Number of | Computation |
|---|---|---|---|
| | Message rounds | messages | power |
| Secure multi- | O(n) | O(n²) | Addition and |
| party computation | | | multiplication |
| Secure circuit | 1 for each AND | 2 for each AND | Full power |
| evaluation | gate | gate | |
| Non-interactive | ½ for a NC¹ | 1 for a NC¹ | Only supports |
| cryptocomputing | circuit | circuit | NC¹ circuits |
| Present invention | ½ for each real | 1 for each real | Full power |
| | number operation | number operation | |

A computational performance comparison is shown below in Table 2. This comparison assumes 32 bits, five multiplications and five additions, 0.1 milliseconds for one communication, 10 nanoseconds for one addition operation, 11 nanoseconds for one multiplication operation, and 0.5 microseconds for one decrypt function for secure circuit evaluation.

TABLE 2
Performance comparison

| Algorithm | Estimated Time |
|---|---|
| Secure Multiparty Computation | 1.01 milliseconds |
| (no full power) | |
| Secure Circuit Evaluation | >128 milliseconds |
| Present invention | 0.11 milliseconds |

The present invention provides a secure computation scheme with a focus on the protection of data privacy. The protocol supports full power computation and is highly efficient. Also, the algorithm is designed to allow aggregate computation of multiple operations. More specifically, a sequence of arithmetic operations can be computed in one round and Alice can provide all the required coefficients to Bob in one message. Thus, it can greatly reduce the communication overhead per operation. If all data references in a program are static, Alice can directly place the required coefficients for all the computations into the code and give it to Bob. Bob can then perform secure computation without any further communication.

As previously mentioned, the present invention can be adapted for precise integer and rational computations. In addition, the present invention can be adapted to provide a protocol for aggregate computation of multiple operations. Compiler techniques will be used to perform data dependency analysis to obtain larger sequences of combinable operations. The transformation techniques for Alice to place all required coefficients in the code if possible can also be developed.

Although preferred embodiments of the present invention have been described in detail, it will be understood by those skilled in the art that various modifications can be made therein without departing from the spirit and scope of the invention as set forth in the appended claims.

1. A method for secure computation on encrypted data, the method comprising the steps of:
receiving a request invoking one or more computations using the encrypted data;
authenticating the request;
obtaining one or more pseudo keys for the encrypted data;
obtaining the encrypted data;
performing the one or more computations on the encrypted data using the pseudo keys; and
providing the results of the one or more computations.

2. The method as recited in claim 1, wherein the one or more computations comprise an operation supported by a computer programming language and the operation comprises an arithmetic operation, a Boolean operation, a comparison operation, a bit-wise operation or a program flow control operation.

3. The method as recited in claim 1, wherein the one or more pseudo keys are derived from one or more encryption keys that were used to create the encrypted data, the one or more pseudo keys do not reveal the one or more encryption keys or the unencrypted data, and the results do not reveal the one or more encryption keys or the unencrypted data.

4. The method as recited in claim 1, wherein the results of the one or more computations comprise encrypted results, new encrypted data or a TRUE/FALSE result.

5. The method as recited in claim 1, further comprising the step of verifying the correctness of the one or more pseudo keys.

6. The method as recited in claim 5, wherein the step of verifying the correctness of the one or more pseudo keys comprises:
obtaining one or more second pseudo keys for the encrypted data from a second source; and
comparing the one or more pseudo keys to the one or more second pseudo keys.

7. The method as recited in claim 1, wherein the encrypted data comprises M components created from data that is decomposed into N partitions and encrypted with M encryption keys where N is greater than or equal to one and M is greater than N.

8. The method as recited in claim 1, further comprising the steps of:
obtaining data to be encrypted;
creating one or more encryption keys for the data;
encrypting the data using the one or more encryption keys
sending the encrypted data to a repository; and
sending the one or more encryption keys to one or more key holders.

9. The method as recited in claim 8, wherein the one or more encryption keys are independently and randomly created or created from one encryption key.

10. The method as recited in claim 8, wherein the step of creating one or more encryption keys for the data comprises the steps of:
decomposing the data into one or more partitions using a decomposition polynomial;
composing each partition with a conversion polynomial; and
creating one or more encryption keys for each conversion polynomial.

11. The method as recited in claim 10, wherein the data is decomposed using a decomposition polynomial wherein:
d represents the data and d₁, d₂, . . . , and d_{N} represent the N partitions of the data;
the decomposition polynomial is a linear function of the N partitions d₁, d₂, . . . , d_{N};
D(d₁, d₂, . . . , d_{N}) denotes the decomposition polynomial;
D(d₁, d₂, . . . , d_{N})=c₁*d₁+c₂*d₂+ . . . +c_{N}*d_{N}, where c₁, c₂, . . . , c_{N} are chosen coefficients of the decomposition polynomial and D(d₁, d₂, . . . , d_{N})=d; and
the N partitions d₁, d₂, . . . , and d_{N} can be chosen arbitrarily as long as D(d₁, d₂, . . . , d_{N})=d is satisfied.

12. The method as recited in claim 11, wherein N is 2 and the decomposition polynomial is D(d₁, d₂)=c₁*d₁+c₂*d₂.

13. The method according to claim 11, wherein c₂=1 and the decomposition polynomial is D(d₁, d₂)=c₁*d₁+d₂.

14. The method as recited in claim 10, wherein the data is decomposed using a nonlinear polynomial function of the N partitions d₁, d₂, . . . , d_{N}.

15. The method as recited in claim 8, wherein the data is encrypted using a conversion polynomial and a key-based coding function where:
d represents the data and d₁, d₂, . . . , and d_{N} represent N partitions of the data using a decomposition function;
Kᵢ represents the i-th encryption key of the M encryption keys;
e represents the encrypted form of the secret data d;
the encrypted form e is a vector of M elements (e₁, e₂, . . . , e_{M});
the i-th element of the encrypted form e is eᵢ and eᵢ is computed from the i-th encryption function;
the i-th encryption function consists of the i-th conversion polynomial and the i-th key-based coding function;
each conversion polynomial is a linear function of the N partitions d₁, d₂, . . . , d_{N};
E^{C}ᵢ(d₁, d₂, . . . , d_{N}) denotes the i-th conversion polynomial, where i=1, 2, . . . , M;
E^{C}ᵢ(d₁, d₂, . . . , d_{N})=sᵢ₁*d₁+sᵢ₂*d₂+ . . . +s_{iN}*d_{N}, where sᵢ₁, sᵢ₂, . . . , s_{iN} are chosen coefficients of the conversion polynomial E^{C}ᵢ(d₁, d₂, . . . , d_{N});
E^{C}₁(d₁, d₂, . . . , d_{N}), E^{C}₂(d₁, d₂, . . . , d_{N}), . . . , and E^{C}_{M}(d₁, d₂, . . . , d_{N}) form a set of linear equations that uniquely determines the N partitions d₁, d₂, . . . , and d_{N};
E^{K}₁(Kᵢ, E^{C}ᵢ(d₁, d₂, . . . , d_{N})) denotes the i-th key-based coding function; and
E^{K}ᵢ(Kᵢ, E^{C}ᵢ(d₁, d₂, . . . , d_{N}))=eᵢ wherein the i-th key-based coding function applies the i-th key Kᵢ to the result computed from E^{C}ᵢ(d₁, d₂, . . . , d_{N}) to obtain the encrypted form eᵢ.

16. The method as recited in claim 15, wherein the conversion polynomial is E^{C}ᵢ(d₁, d₂)=sᵢ₁*d₁+sᵢ₂*d₂, where i=1, 2, . . . , M.

17. The method as recited in claim 15, wherein the key-based coding functions are E^{K}₁(Kᵢ, E^{C}ᵢ(d₁, d₂, . . . , d_{N}))=Kᵢ*E^{C}ᵢ(d₁, d₂, . . . , d_{N}), where i=1, 2, . . . , M.

18. The method as recited in claim 15, wherein M=2 and the key-based coding functions are E^{K}₁(K₁, E^{C}ᵢ(d₁, d₂))=K₁*s₁₁*d₁+K₁*s₁₂*d₂ and E^{K}₂(K₂, E^{C}₂(d₁, d₂))=K₂*s₂₁*d₁+K₂*s₂₂*d₂.

19. An apparatus for secure computation on encrypted data comprising:
a server;
one or more sources of encrypted data communicably coupled to the server;
one or more key holders communicably coupled to the server;
the server capable of receiving a request invoking one or more computations using the encrypted data, requesting one or more pseudo keys for the encrypted data from the one or more key holders, obtaining the encrypted data, performing the one or more computations on the encrypted data using the pseudo keys and providing the results of the one or more computations; and
the one or more key holders capable of receiving the request for the one or more pseudo keys, computing the one or more pseudo keys and providing the one or more pseudo keys to the server.

20. A system for secure computation on encrypted data comprising:
one or more client devices;
a server communicably coupled to the one or more client devices via a network;
one or more sources of encrypted data communicably coupled to the server;
one or more key holders communicably coupled to the server;
an encryption module communicably coupled to the server, the one or more sources of encrypted data or the one or more key holders;
the encryption module capable of obtaining data to be encrypted, creating one or more encryption keys for the data, encrypting the data using the one or more encryption keys, sending the encrypted data to the one or more sources of encrypted data and storing the one or more encryption keys in the one or more key holders;
the server capable of receiving a request invoking one or more computations using the encrypted data, requesting one or more pseudo keys for the encrypted data from the one or more key holders, obtaining the encrypted data, performing the one or more computations on the encrypted data using the pseudo keys and providing the results of the one or more computations; and
the one or more key holders capable of receiving the request for one or more pseudo keys, computing the one or more pseudo keys and providing the one or more pseudo keys to the server.
